(19) United States
(12) Patent Application Publication
(10) Pub. No.: US 2014/0027487 A1
(43) Pub. Date: Jan. 30, 2014

(54) Drywall Corner Bead Nailer and Method

(71) Applicant: Richard M. Patterson, Hendersonville, NC (US)

(72) Inventor: Richard M. Patterson, Hendersonville, NC (US)

(21) Appl. No.: 13/557,380

(22) Filed: Jul. 25, 2012

(51) Int. Cl. B25C 1/18; B23P 11/00; B25C 1/06; B25C 1/10; B25C 1/04

(52) U.S. Cl. 227/9; 227/129; 227/130; 227/131; 29/432

(57) ABSTRACT

The invention is a dual head mechanical nailer and method capable of driving a pair of nails, screws, staples, or other forms of attachments into a drywall corner bead at an offset orientation and at an angle where each of the attachment means is ninety degrees from the other. The nailer can be powered by combustible fuel, by pneumatic power, by electric power supplied by a battery, or by electric power supplied by an electrical service connection. A magazine of nails, screws, staples, or other forms of attachments may be attached to each head of the mechanical nailer for supplying the respective head with the respective attachment.

### TECHNICAL FIELD AND BACKGROUND OF INVENTION

The present invention relates to the field of drywall construction. More specifically, the invention relates to the field of the installation of drywall corner beads. The invention is a dual head mechanical nailer capable of driving a pair of nails, screws, staples, or other attachment means into a drywall corner bead at an offset orientation and at an angle where each of the attachment means is ninety degrees from the other.

Drywall is a type of construction material used for interior walls and ceilings. Drywall is gypsum pressed between two pieces of paper and was developed during the early twentieth century as an alternative to lath and plaster. Whereas lath and plaster installation might take a week or more for a typical house, drywall can be installed in just a few days. Lath and plaster installation is also much more expensive than modern drywall. Drywall is typically formed into large sheets which are nailed, screwed, stapled, or otherwise attached to stud walls or to other types of walls depending on the installation. The nails/screws can be attached with a hammer or manual screwdriver but are more typically attached by using an electromechanical nailer or a screw gun. Such an electromechanical nailer or screw gun can operate pneumatically or by power supplied via an electric battery, electrical service connection, or combustible fuel. In any of these cases, the electromechanical nailer or screw gun attaches one nail/screw at a time to the surface. Once the sheets of drywall are attached to the walls, the seams of the sheets are first taped, then covered with a drywall compound, and then sanded in a process called floating. This process can be repeated to achieve a smooth finish.

It is typical in the installation of drywall to encounter a ninety degree corner protruding into a room or at the edge of a room such as with a doorway, window, niche, tray ceiling, or other opening. Since the drywall is gypsum sandwiched between two pieces of paper, there is no finished paper edge and only rough gypsum at the corner. It is typical in such a situation to install a corner bead that covers the rough gypsum and protects the corner. This corner bead is typically made of a thin metal but it could be made from other materials such as plastic or heavy paper as well. The corner bead is typically an angle at ninety degrees though other angles are sometimes used. The corner bead may have a series of holes disposed along its edges and it may have the tape pre-attached such that the tape would overlap the drywall.

Because the corners such as described above protrude out into a room or lead into another room, they are often highly visible Imperfections in the installation of the corner bead are thus highly visible to the naked and untrained eye. If the corner bead is improperly installed, the corner bead may not be perpendicular to the floor and ceiling if desired in an installation or the corner edge might not be a straight and even one. Unfortunately, the installation techniques currently available and in use for decades make it likely that a corner bead will be installed in such an undesirable manner. Currently, most drywall installers attach a corner bead to a wall by holding it in place while nailing/screwing one side edge and then nailing/screwing the other side edge. Some installers use a mechanical device that crimps tabs of the corner bead into the drywall as a temporary way of holding the corner bead to the drywall while the nails/screws are inserted. However, the crimps are not permanent and the corner bead can become dislodged during the nailing/screwing process or during the process of other construction in the vicinity. Further, the nails/screws are attached one-by-one and it is very common for the corner bead to move or become displaced in one direction when a nail/screw is attached to one side and for it then to move or become displaced in the other direction when a second nail/screw is attached to the other side of the corner bead. Because of this movement and because of the frequency of improper or less than desirable installation, the corner bead must sometimes be removed and reapplied in an attempt to get the corner finish as straight as possible.

Thus, there is a need in the art for a device and method of installing drywall corner beads that allows the corner beads to be installed quickly, attractively, and correctly the first time.

### SUMMARY OF THE INVENTION

Unless otherwise stated, for simplicity as used herein, the term “nail” is defined to be inclusive of nails, screws, staples, brads, etc . . . . It is, thus, an object of the present invention to provide a device and method of installing a drywall corner bead where the nails are applied perpendicularly to the outer flat surfaces of the corner bead and wherein the nails are applied simultaneously so that the corner bead does not move during installation. Further, it is an object of the invention to provide a device and method of installing a drywall corner bead where the corner bead does not need to use temporary tabs or clamps to hold it in place and can be attached correctly the first time without need for later adjustment. Accordingly, the invention is a dual head drywall corner bead nailer and method capable of driving a pair of nails into a drywall corner bead at an offset orientation and at an angle where each nails is ninety degrees from the other in a situation where the corner bead is likewise positioned at ninety degrees.

Accordingly, each head of the pair of dual heads is identical in function and is capable of attaching the nails through the corner bead and into the drywall or other underlying substrate. The dual heads are offset so that when the nails are driven into the drywall corner beads, the nails do not touch. As such, one of the heads will drive the nail slightly below the nail driven by the other head, relative to the corner bead being perpendicular to the floor if desired for a particular installation.

It is a further object of the invention that the nailer can be utilized for purposes other than drywall installation such as for the installation of wooden, metal, or plastic trim, in cabinet making, or in any other construction or craft project where simultaneous angled nailing is required.

In one embodiment, the dual heads are attached to each other and to a common power source. The dual heads are actuated by a common actuator switch or trigger and the nails are supplied by a pair of magazines of nails, one magazine for each head of the dual heads. Each of the heads comprises a piston and a plunger that pushes the nail out of the magazine, through an opening in the safety, and into the drywall corner bead.

According to an embodiment of the invention, the nailer also includes an alignment edge at a ninety degree angle that meets the ninety degree angle of the drywall corner bead. The nail is applied at each end of the alignment edge. The nailer may also include a safety on each of the heads that contacts the corner bead when nailing is engaged such that actuation of the trigger and of the safety actuates the piston and the plunger that pushes the nail out of the magazine, through an opening in the safety, and into the drywall corner bead.

According to one embodiment of the invention, the power source is a combustible fuel. The combustible fuel may be supplied in a prepackaged canister. The corner nailer has a chamber into which the canister is inserted. This chamber may be located in the handle of the nailer. A nipple is attached to the canister and a tube is attached to the nipple. The tube supplies fuel from the canister to one or more ignition chambers. The ignition chambers may be located near or within the heads of the nailer. The corner nailer may also have a battery that supplies a charge to the ignition chamber. This battery may also be located within the handle. When the trigger is actuated, a predetermined amount of fuel and air are mixed and the charge from the battery ignites the fuel. The ignition combusts the fuel and pushes the piston and plunger and thus drives the nail through an opening in the safety and into the corner bead.

According to another embodiment, there is a single ignition chamber that drives the pistons and plungers to simultaneously drive the nails.

According to another embodiment, there are two ignition chambers, each fueled by the single canister of fuel, and ignition occurs simultaneously, thus simultaneously driving the pistons and plungers and thus the nails.

According to another embodiment, there are two ignition chambers, and two fuel canisters. There is a single battery and ignition occurs simultaneously, thus simultaneously driving the pistons and plungers and thus the nails.

According to another embodiment, the nails are driven by electric power supplied by a battery. The battery may be located in the handle.

According to another embodiment, the nails are driven by electric power supplied by an electric service connection. The electric service connection may be removably attached to the nailer via an electric cable.

According to another embodiment, the nails are driven by pneumatic power supplied by either a compressed gas canister or by compressed gas supplied by a hose connection to a compressor. The gas contained in the gas canister may be air or it may be a gas such as carbon dioxide or nitrogen. The gas canister may be integral to the device or it may be external with connection via a hose.

According to another embodiment of the invention, the angle between the heads may be adjusted from ninety degrees to accommodate different corner bead angles that are either greater than or less than ninety degrees.

According to another embodiment of the invention, the magazine of nails is parallel to the corner bead that is being installed when the nailer is held in the position wherein nails are installed.

According to another embodiment of the invention, the magazine of nails is perpendicular to corner bead that is being installed when the nailer is held in the position wherein nails are installed.

### BRIEF DESCRIPTION OF THE DRAWING FIGURES

Features, aspects, and advantages of a preferred embodiment of the invention are better understood when the detailed description is read with reference to the accompanying drawing, in which:

FIG. 1 is a perspective view of the invention showing the nails and nail strips in the magazine;

FIG. 2 is a bottom perspective view of the invention showing the handle and trigger;

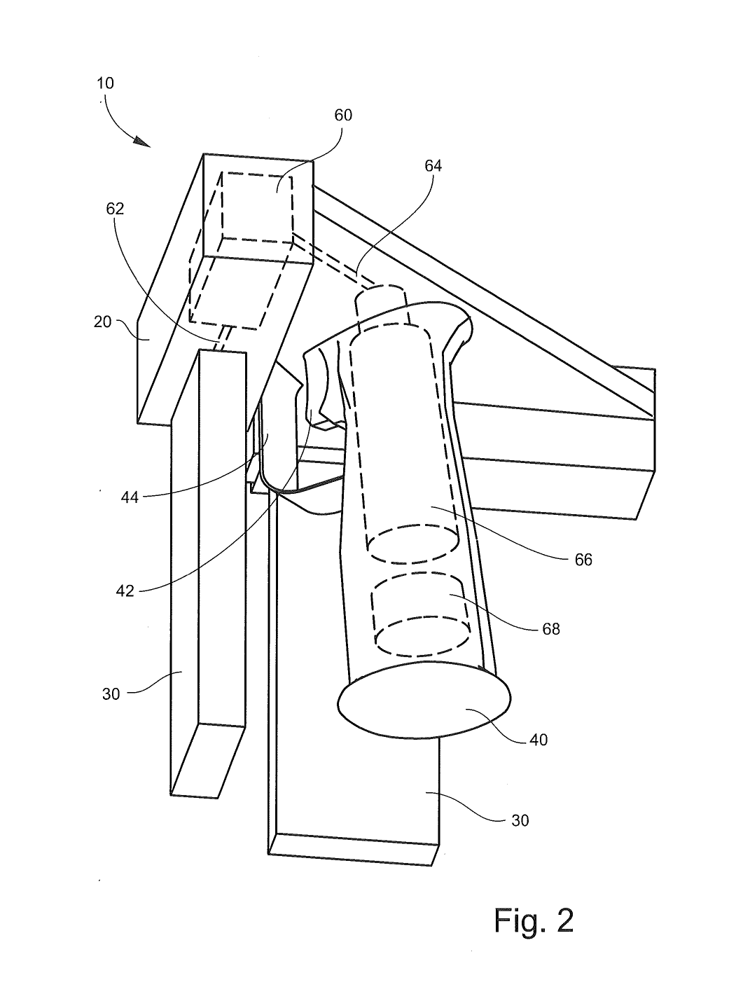

FIG. 3 is a perspective view of the invention showing the offset orientation and the relation to the corner bead;

FIG. 4 is a side view of the invention showing the offset and angled orientation with nail strips in the magazine and a nail in the head;

FIG. 5 is a top view of the invention showing the right angled orientation of the heads;

FIG. 6 is a front view of the invention showing the offset orientation of the heads;

FIG. 7 is a bottom perspective view of the invention showing the electric service connection;

FIG. 8 is a bottom perspective view of the invention showing the connection to a compressed gas canister; and

FIG. 9 is a bottom perspective view of the invention showing the connection to an air compressor.

### DETAILED DESCRIPTION:

It is to be understood by a person having ordinary skill in the art that the present discussion is a description of exemplary embodiments only and is not intended as limiting the broader aspects of the present invention. The following example is provided to further illustrate the invention and is not to be construed to unduly limit the scope of the invention.

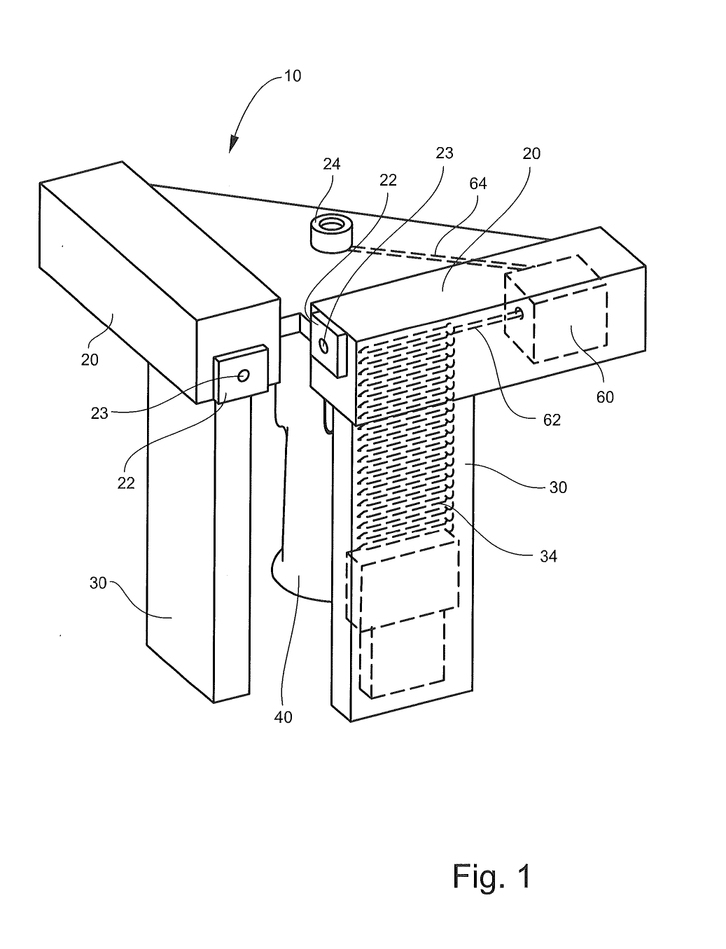

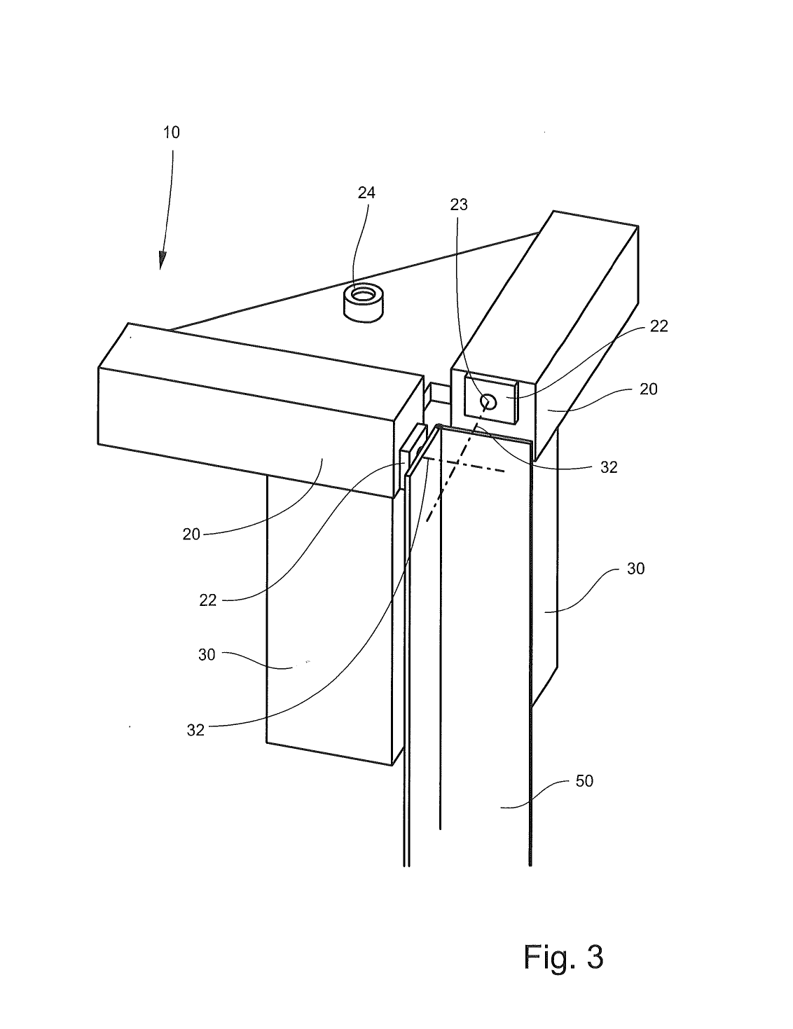

Referring now to the drawings, FIG. 1 shows a view of the dual head mechanical nailer 10. The nailer 10 has two heads 20. Each of the heads 20 has a safety 22 attached to the heads 20. Safety openings 23 are the exit points for nails 32 that are driven through safety openings 23 into the corner bead 50 as shown in FIG. 3. Each head 20 also has a magazine 30 attached to it. The magazines 30 are shown as being parallel to the corner bead 50 but the orientation may also be perpendicular or at some other angle or the magazine 30 may be arcuate depending on a particular embodiment or depending on the types of the strips of nails 34. As shown in FIG. 1, the magazine 30 is loaded with strips of nails 34. When the safety 22 is pressed against a corner bead 50 as shown in FIG. 3 and the strips of nails 34 are loaded into the magazines 30, the nailer 10 is in position to simultaneously drive two nails 32, one nail 32 from each magazine 30, through safety openings 23 into the corner bead 50. The nail 32 is driven into the corner bead 50 when both of the safeties 22 are pressed against the corner bead 50 and when the trigger 42 is actuated as shown in FIG. 3. The trigger 42 is protected against accidental operation and damage by trigger guard 44.

FIG. 1 also shows fuel port 24 which may accept a canister of fuel 66 stored in the handle 40 if the mechanical nailer 10 is of the embodiment that utilizes combustible fuel as a power source. Such an embodiment may have also have a battery 68 stored in the handle 40. The battery provides an electric charge for igniting the fuel from the fuel canister 66 and may also provide power for resetting the nailer 10 after the driving of a pair of nails 32. The fuel from the fuel canister 66 is delivered to an ignition chamber 60 via a tube 64. The fuel from the canister 66 in the fuel port 24 may be ignited in one or more ignition chambers 60 located within the heads 10.

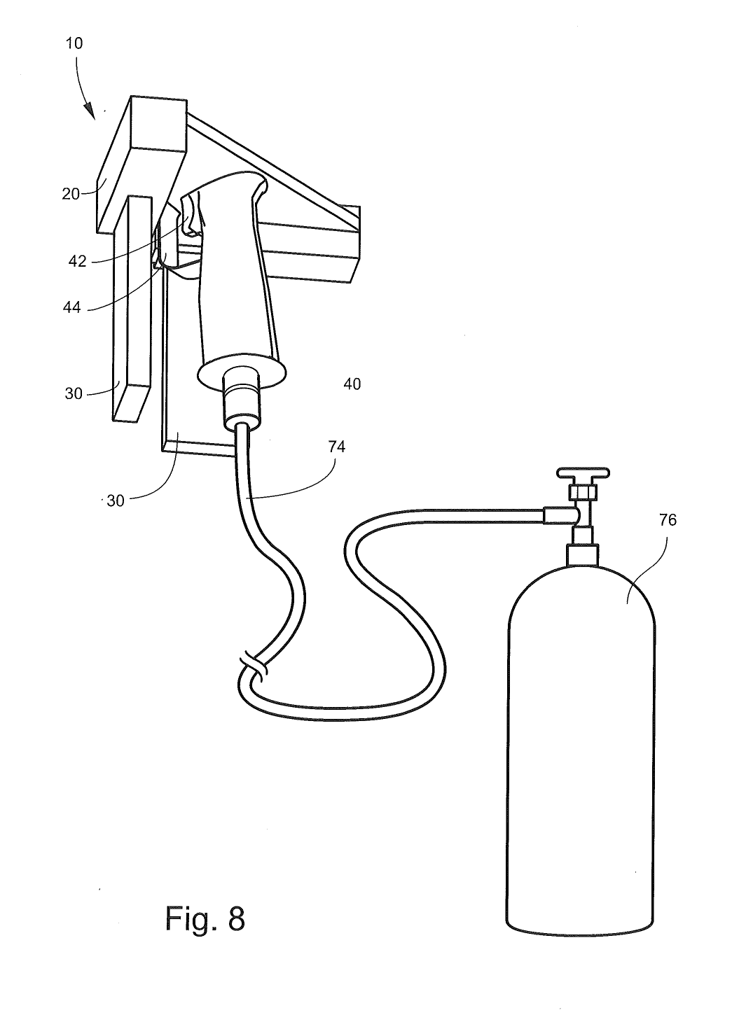

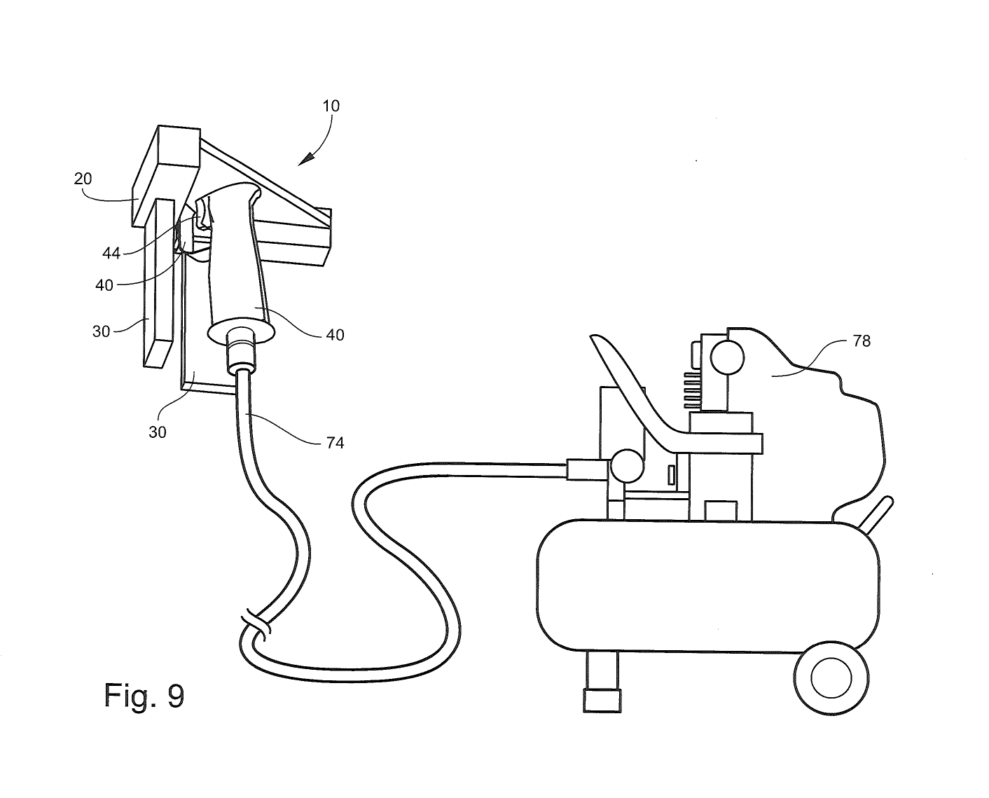

Similarly, in an embodiment wherein the fuel is not combustible fuel but is compressed gas contained within the nailer 10, a canister of compressed gas may use fuel port 24 if the nailer 10 is of the embodiment that uses compressed gas for pneumatic power. Or, as shown in FIG. 8, if the compressed gas is supplied to the nailer 10 by an external canister 76 a hose 74 may be attached if the nailer 10. Or, as shown in FIG. 9, if the compressed gas is supplied by an external compressor 78, a hose 74 may connect the compressor 78 to the nailer 10. The compressed gas may be Nitrogen, Carbon Dioxide, air, or some other gas.

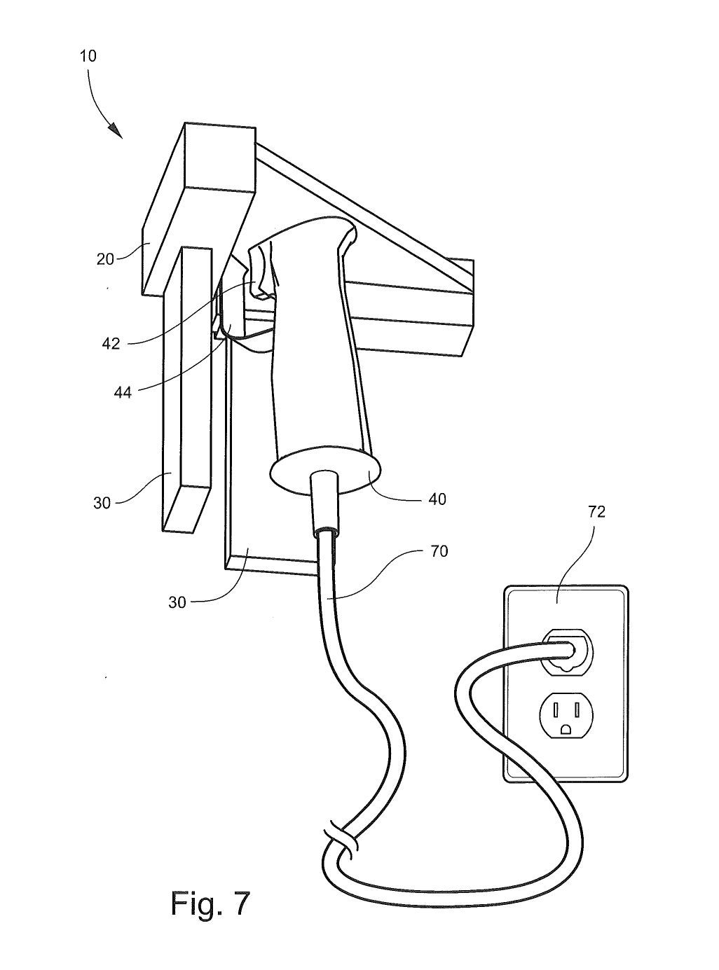

In some embodiments, a battery 68 may be inserted into handle 40 if the nailer 10 is of the embodiment that utilizes battery power for operation. A battery 68 may also be inserted into the handle 40 if the nailer 10 is of the embodiment that uses a battery to reset the pistons and plunger 62 in an embodiment driven by an internal or external compressed gas canister 76. Likewise, as best shown in FIG. 7, an electrical service connection 72 via a wire 70 may be attached at handle 40 if the nailer 10 is of the embodiment that utilizes electrical service power 72.

In such an embodiments as thus described using fuel canisters 66, gas canisters 76 or compressors 78, battery 68, or electrical service connection 72, each of the heads 20 may have within the heads 20 a piston and a plunger 62 that pushes the nail 32 out of the magazine 30, through safety opening 23 in the safety 22, and into the drywall corner bead 50. The combustion of the fuel in the ignition chamber 60, or the operation of pneumatic or electric force would actuate the piston and plunger 62 thus driving the nail 32.

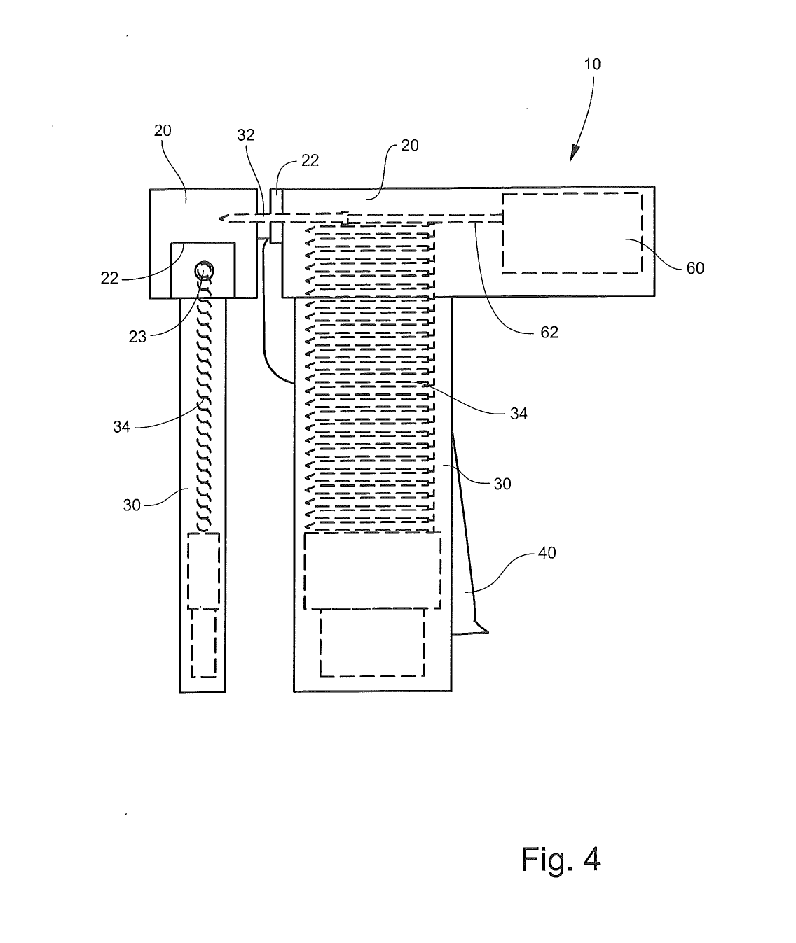

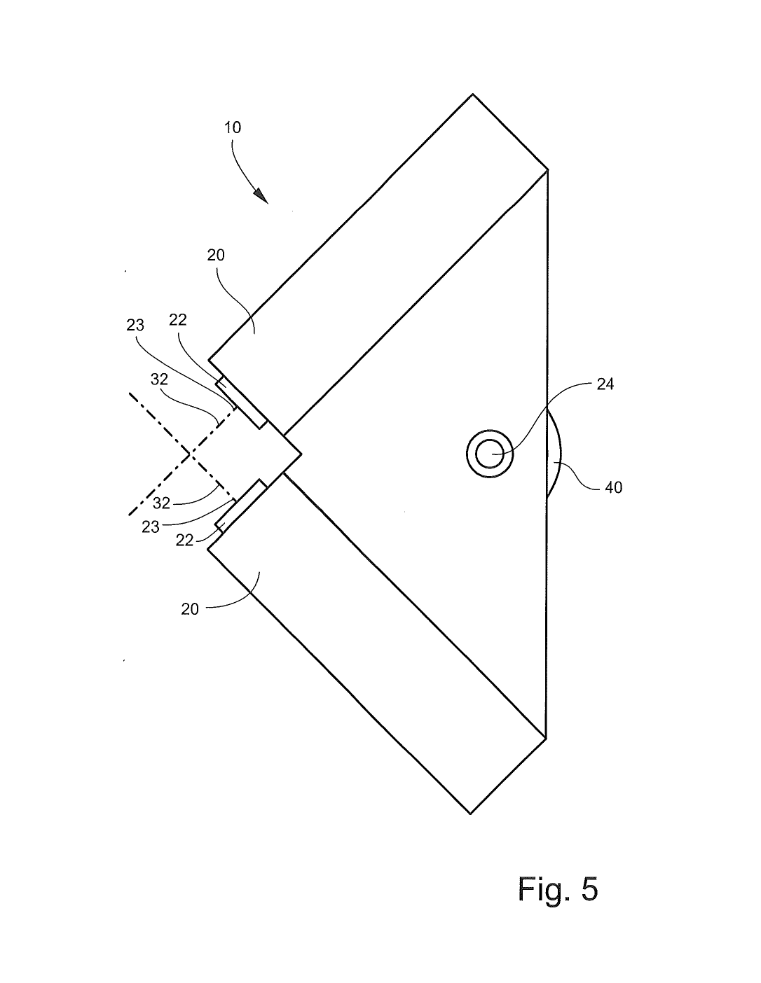

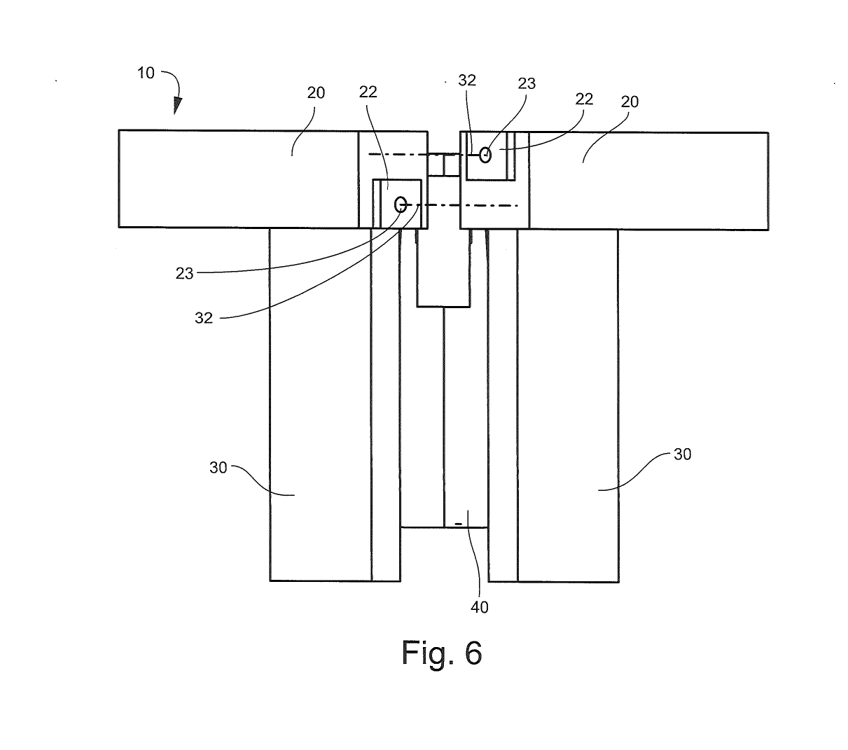

As shown in FIGS. 4, 5, and 6, the nail heads 20 of the nailer 10 are oriented at 90 degrees from each other and the ejection of the nail 32 is oriented at a vertically offset orientation. The nails 32 are thus driven into the corner bead 50 at a 90 degree angle from each other. Also, the nails 32 are driven at a vertically offset orientation as best shown in FIGS. 4 and 6 so that, once driven into the corner bead 50, the nails 32 do not touch each other. The safeties 22 are shown with one located at a lower portion of the head 20 and the other safety 22 located at an upper portion of the other head 20 thus correlating with the offset orientation.

In a typical application, an installer will use a dual head mechanical nailer with offset nail orientation 10 to attach a drywall corner bead 50 to a drywall corner. The installer will place the corner drywall bead 50 over the drywall corner. The installer will align the dual head mechanical nailer 10 with the corner drywall bead 50 and then press the dual head mechanical nailer 10 against the corner drywall bead 50. The safety 22 will press against the drywall corner bead 50. The installer will check alignment and then actuate the trigger 42 thereby simultaneously driving the nails 32 into the corner drywall bead 50. The installer will repeat the nailing process until the corner bead 50 is securely attached to the drywall.

A drywall corner bead nailer 10 and method of nailing a drywall corner bead 50 using a drywall corner bead nailer 10 according to the invention has been described with reference to specific embodiments and examples. Various details of the invention may be changed without departing from the scope of the invention. Furthermore, the forgoing description of the preferred embodiments of the invention and the best mode for practicing the invention are provided for the purpose of illustration only and not for the purpose of limitation, the invention being defined by the claims.

I claim:

1. A dual head mechanical nailer comprising:
a. a pair of nailing heads that drive a pair of nails and are attached to each other at a ninety degree angle;
b. a power source operatively connected to the nailing heads for providing driving power to the nailing heads;
c. a trigger actuator operatively connected to the power source and to the nailing heads such that actuation of the trigger actuator causes the pair of nails to be ejected from the pair of nailing heads and to be driven into an exterior surface;
d. a pair of nail magazines wherein each one of the magazines is attached to one of the nailing heads for supplying nails to the nailing heads; and
e. a handle attached to and located between the nailing and adjacent the trigger actuator for holding the mechanical nailer while driving nails.

2. The dual head mechanical nailer of claim 1 wherein the nails driven by the pair of nailing heads are vertically offset such that the pair of nails, once driven, will each be in a different plane.

3. The dual head mechanical nailer of claim 1 wherein the power source is a combustible fuel.

4. The dual head mechanical nailer of claim 1 wherein the power source is pneumatic power supplied by an internal compressed gas canister.

5. The dual head mechanical nailer of claim 1 wherein the power source is pneumatic power supplied by an external air compressor connected to the nailer by a hose.

6. The dual head mechanical nailer of claim 1 wherein the power source is pneumatic power supplied by an external compressed gas canister connected to the nailer by a hose.

7. The dual head mechanical nailer of claim 1 wherein the power source is electric power supplied by a battery.

8. The dual head mechanical nailer of claim 1 wherein the power source is electric power supplied by an electrical service connection.

9. The dual head mechanical nailer of claim 3 wherein the pair of magazines are attached to the nailing heads at an angle parallel to the length of a corner bead that is being attached by the nails driven by the mechanical nailer.

10. The dual head mechanical nailer of claim 3 wherein the pair of magazines are attached to the nailing heads at an angle perpendicular to the length of a corner bead that is being attached by the nails driven by the mechanical nailer.

11. The dual head mechanical nailer of claim 3 further comprising a battery removably attached to the nailer for supplying an electrical charge for ignition of the combustible fuel and wherein the combustible fuel is contained within a single canister removably attached to the nailer and operably connected to each of the pair of nailing heads.

12. The dual head mechanical nailer of claim 3 further comprising a battery removably attached to the nailer for supplying an electrical charge for ignition of the combustible fuel and wherein the combustible fuel is contained within a pair of canisters where each one of the pair of canisters is removably attached to the nailer and each one of the pair of canisters is operably connected to one nailing head of the pair of nailing heads.

13. The dual head mechanical nailer of claim 12 wherein the angle between each one of the pair of heads is adjustable to an angle of ninety degrees, an angle of greater than ninety degrees, or an angle of less than ninety degrees.

14. A dual head mechanical nailer comprising:
a. a pair of nailing heads that are attached to each other at a ninety degree angle and that drive a pair of nails at a vertically offset orientation such that the pair of nails, once driven, will each be in a different plane;
b. a combustible fuel power source contained within a canister that is removably attached to the mechanical nailer and that is operably connected to a pair of ignition chambers which are each operably connected to one of the nailing heads for providing the driving power to the nailing heads;
c. a battery that is removably attached to the mechanical nailer and that is operably connected to the pair of ignition chambers for supplying an electrical charge for ignition of the combustible fuel;
d. a pair of safety mechanisms wherein each one of the safety mechanisms is attached to one nailing head of the pair of nailing heads;
e. a trigger actuator operably connected to the pair of safety mechanisms, to the battery, to the pair of ignition chambers, and to the nailing heads such that actuation of the trigger actuator causes the pair of nails to be simultaneously ejected from the pair of nailing heads and to be driven into an exterior surface;
f. a pair of nail magazines wherein each one of the magazines is attached to one of the nailing heads for supplying nails to the nailing heads; and
g. a handle attached to and located between the nailing and adjacent the trigger actuator for holding the mechanical nailer while driving nails.

15. The dual head mechanical nailer of claim 14 wherein the pair of magazines are attached to the nailing heads at an angle parallel to the length of a corner bead that is being attached by the nails driven by the mechanical nailer.

16. The dual head mechanical nailer of claim 14 wherein the pair of magazines are attached to the nailing heads at an angle perpendicular to the length of a corner bead that is being attached by the nails driven by the mechanical nailer.

17. The dual head mechanical nailer of claim 14 wherein the angle between each one of the pair of heads is adjustable to an angle of ninety degrees, an angle of greater than ninety degrees, or an angle of less than ninety degrees.

18. A method of nailing a corner drywall bead to a drywall corner comprising the steps of:
a. supplying a dual head mechanical nailer comprising a handle, a trigger actuator, a pair of nail magazines for containing a plurality of nails, and a pair of nailing heads attached to each other at a ninety degree angle that drive a pair of nails from the magazines at a vertically offset orientation such that the pair of nails, once driven, will each be in a different plane;
b. supplying a drywall corner, a corner drywall bead, and a plurality of nails that coordinate with the magazines of the dual head mechanical nailer supplied in step a;
c. placing the corner drywall bead over the drywall corner;
d. aligning the dual head mechanical nailer with the corner drywall bead;
e. pressing the dual head mechanical nailer against the corner drywall bead;
f. actuating the trigger actuator thereby driving nails into the corner drywall bead;
g. repeating step d through step g until the corner drywall bead has been securely nailed to the drywall corner.
